(19) United States
(12) Patent Application Publication
(10) Pub. No.: US 2026/0225472 A1
(43) Pub. Date: Aug. 6, 2026

(54) ELECTRIFIED VEHICLE BATTERY MODULE ASSEMBLY AND METHOD FOR ASSEMBLING SAME

(71) Applicant: FCA US LLC, Auburn Hills, MI (US)

(72) Inventors: Daniel Hornback, Auburn Hills, MI (US); Zachary Cook, Auburn Hills, MI (US)

(21) Appl. No.: 19/042,151

(22) Filed: Jan. 31, 2025

(51) Int. Cl. B60L 50/64; H01M 50/209; H01M 50/224; H01M 50/244; H01M 50/271; H01M 50/289; H01M 50/517

(52) U.S. Cl. CPC B60L 50/64; H01M 50/209; H01M 50/224; H01M 50/244; H01M 50/271; H01M 50/289; H01M 50/517

(57) ABSTRACT

A battery pack assembly includes a housing assembly and a battery module assembly. The battery module assembly comprises: a first battery module that houses a first plurality of battery cells therein, the first battery module having a first enclosure including a first sidewall and a second sidewall; and a second battery module that houses a second plurality of battery cells therein, the second battery module having a second enclosure including a first sidewall and a second sidewall. the first sidewall of the first battery module interlocks with the second sidewall of the second battery module in an assembled position.

### FIELD

The present application generally relates to electrified vehicles and, more particularly, to a battery pack assembly having a battery module housing including a collection of interlocking battery modules received in a battery frame.

### BACKGROUND

An electrified vehicle (hybrid electric, plug-in hybrid electric, range-extended electric, battery electric, etc.) includes at least one battery system and at least one electronic drive module having an electric motor and associated electric drive gearbox assembly. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor. The high voltage battery system generally includes a battery pack or module assembly that includes a housing that houses one or more battery modules. Conventional battery module assemblies often require multiple structural components to ensure the integrity and safety of the battery system, leading to increased weight, manufacturing complexity, and cost. Conventional battery module assemblies usually require extensive fasteners or other methods of coupling the individual modules to cross members arranged within the main battery pack. In this regard, Accordingly, while such battery module assemblies do work well for their intended purpose, there is a desire for improvement in the relevant art.

### SUMMARY

According to one example aspect of the invention, a battery pack assembly includes a housing assembly and a battery module assembly. The battery module assembly comprises: a first battery module that houses a first plurality of battery cells therein, the first battery module having a first enclosure including a first sidewall and a second sidewall; and a second battery module that houses a second plurality of battery cells therein, the second battery module having a second enclosure including a first sidewall and a second sidewall. the first sidewall of the first battery module interlocks with the second sidewall of the second battery module in an assembled position.

In some implementations, the first sidewall of the first enclosure further comprises a first lateral frame extension portion and a first wing that collectively define a first groove therebetween.

In some implementations, the second sidewall of the second enclosure further comprises a second lateral frame extension portion and a second wing that collectively define a second groove therebetween.

In some implementations, the first lateral frame extension portion of the first enclosure locates into the second groove of the second enclosure in an interlocking relationship in the assembled position.

In some implementations, the battery pack assembly further comprises a first bolt that extends through a first aperture extending through the first sidewall of the first enclosure and a second aperture extending through the second sidewall of the second enclosure.

In additional aspects, the battery pack assembly further comprises a first nut that threadably secures to the first bolt.

In additional features, the battery pack assembly further comprises a top cover positioned between the nut and the first battery module.

In other features the battery pack assembly further comprises, a third battery module that houses a third plurality of battery cells therein, the third battery module having a third enclosure including a first sidewall and a second sidewall; wherein the second sidewall of the first battery module interlocks with the first sidewall of the third battery module in an assembled position.

In additional arrangements, the first, second and third battery modules comprises a first layer of interconnected adjacent battery modules. The battery pack assembly further includes a fourth battery module that houses a fourth plurality of battery cells therein, the fourth battery module having a fourth enclosure including a first sidewall and a second sidewall; a fifth battery module that houses a fifth plurality of battery cells therein, the fifth battery module having a fifth enclosure including a first sidewall and a second sidewall; wherein the first sidewall of the fourth battery module interlocks with the second sidewall of the fifth battery module and comprises a second layer of interconnected adjacent battery modules in an assembled position.

In some examples, the first bolt further extends through extends through a first aperture extending through the first sidewall of the fourth enclosure and the second aperture extending through the second sidewall of the fifth enclosure.

In implementations, the first and second enclosures are formed of extruded aluminum.

A method of assembling a battery pack assembly includes: providing a first battery module that houses a first plurality of battery cells therein, the first battery module having a first enclosure including a first sidewall and a second sidewall; providing a second battery module that houses a second plurality of battery cells therein, the second battery module having a second enclosure including a first sidewall and a second sidewall; locating a long bolt through a hole defined in a bottom tray; advancing the first battery module onto the bottom tray including passing the long bolt through a first aperture defined in the first enclosure; advancing the second battery module onto the bottom tray including passing the long bolt through a second aperture defined in the second enclosure; and interlocking the first sidewall of the first battery module with the second sidewall of the second battery module in an assembled position.

In additional features, the first sidewall of the first enclosure further comprises a first lateral frame extension portion and a first wing that collectively define a first groove therebetween.

In other features, the second sidewall of the second enclosure further comprises a second lateral frame extension portion and a second wing that collectively define a second groove therebetween.

In additional features, the interlocking further comprises locating the first lateral frame extension portion of the first enclosure into the second groove of the second enclosure in an interlocking relationship in the assembled position.

In other implementations, the method further includes welding the long bolt to the tray.

In additional features, the method includes: locating a top cover onto the bolt; and threadably advancing a nut onto the long bolt.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a battery pack assembly according to various principles of the present application;

FIG. 2A is a top perspective view of a battery module assembly including a battery frame that receives a plurality of battery modules according to various principles of the present application;

FIG. 2B is a top perspective view of the battery module assembly of FIG. 2A shown with a housing cover plate removed;

FIG. 3 is a front perspective view of a single module of the battery module assembly of FIG. 2A;

FIG. 4 is a front view of two modules of the battery module assembly shown prior to being moved into an interlocking position;

FIG. 5 is side view of the module assembly of FIG. 2 showing two layers of modules for a high energy application, the two layers interconnected with bolts that connect frame extension portions of respective first and second interconnected modules;

FIG. 6 is a side view of a module assembly during an exemplary first assembly step showing long bolts being passed through holes in the bottom tray of the housing assembly and affixed thereto;

FIG. 7 is a side view of the module assembly of FIG. 6 during an exemplary second assembly step showing the housing assembly flipped over to prepare for the insertion of the modules;

FIG. 8 is a side view of the module assembly of FIG. 7 during an exemplary third assembly step showing a first layer of modules being inserted into the housing using the long bolts as guiding pins;

FIG. 9 is a side view of the module assembly of FIG. 8 during an exemplary fourth assembly step showing a second layer of modules being inserted into the housing using the long bolts as guiding pins;

FIG. 10 is a side view of the module assembly of FIG. 9 during an exemplary fifth assembly step showing all of the modules of the first and second layer inserted and a cover installed over the corresponding bolts; and

FIG. 11 is a side view of the module assembly of FIG. 10 during an exemplary sixth assembly step showing a liquid tight rubber gasket applied over each bolt and a corresponding nut engaged over each bolt and torqued to a proper specification.

### DESCRIPTION

As discussed above, a high voltage battery system in an electrified vehicle generally includes a battery pack or module assembly that includes a housing that houses one or more battery modules. Conventional battery module assemblies often require multiple structural components to ensure the integrity and safety of the battery system, leading to increased weight, manufacturing complexity, and cost. Conventional battery module assemblies also require extensive fasteners or other methods of coupling the individual modules to cross members arranged within the main battery pack.

The instant disclosure provides a high voltage electrified vehicle battery pack mechanical structure built by interconnecting the module enclosures with one another. The module enclosures are configured to fit tightly against one another like puzzle pieces in the assembly process. Long blots are passed through overlapping sidewalls of the module enclosures, affixing them to one another in a rigid manner. The resulting interconnected sidewalls of the modules form a structural cross-beam spanning the width of the battery pack.

The module enclosures serve a dual purpose. First, the module enclosure encases the battery cells of the module, with all of its typical module functions; facilitating busbar connections between cells, individual cell fixation, containment of thermal runway, thermal management of cells, protection of cells against contamination, etc. Second, the module enclosure provides structural rigidity to the battery pack sufficient to protect its contents against impact, vibration and shock. This function is novel for module enclosures as such functionality was previously accomplished by dedicated cross-beams.

The following description provides a battery module assembly having a battery module housing including a collection of interlocking battery modules received in a battery housing assembly. The battery module assembly of the present disclosure mitigates the drawbacks associated with conventional battery module assemblies including, but not limited to, complexity and weight associated with the structural design of electrified vehicle battery packs.

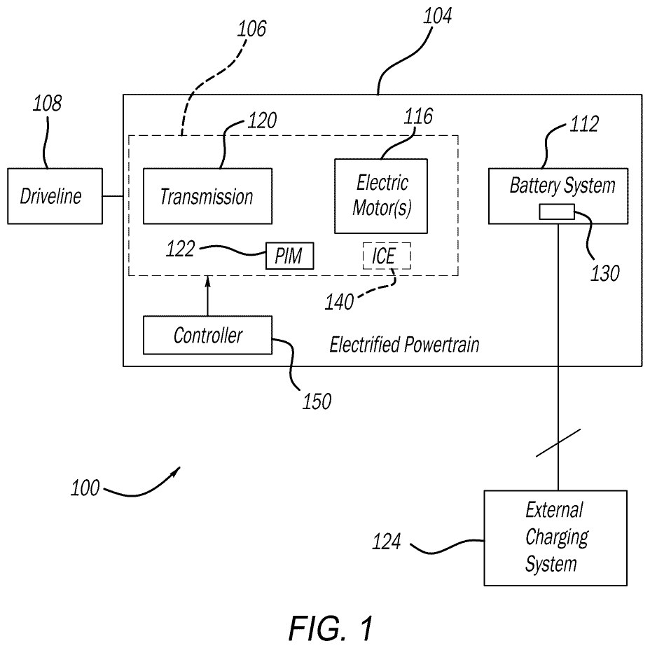

Referring now to FIG. 1, a functional block diagram of an example electrified vehicle 100 (also referred to herein as “vehicle 100”) according to the principles of the present application is illustrated. The vehicle 100 includes an electrified powertrain 104 having an electric drive module (EDM) 106 configured to generate and transfer drive torque to a driveline 108 for vehicle propulsion. The EDM 106 generally includes one or more electric drive units or motors 116 (e.g., electric traction motors), an electric drive gearbox assembly or transmission 120, and power electronics including a power inverter module (PIM) 122.

The electric motor 116 is selectively connectable via the PIM 124 to a high voltage battery system 112 for powering the electric motor 116. The battery system 112 is selectively connectable (e.g., by the driver) to an external charging system 124 (also referred to herein as “charger 124”) for charging of the battery system 112. The battery system 112 includes at least one battery pack assembly 130. In some examples, the electrified powertrain 104 can be a hybrid powertrain that additionally includes an internal combustion engine 140. A heating cooling and air conditioning (HVAC) system 142 can provide communicate air to various systems of the electrified vehicle 100 such as to the EDM 106 and the battery system 112. A controller 150 can provide various inputs to the EDM 106 related to selectively switching power inputs between the electric motors 116 and the ICE 140.

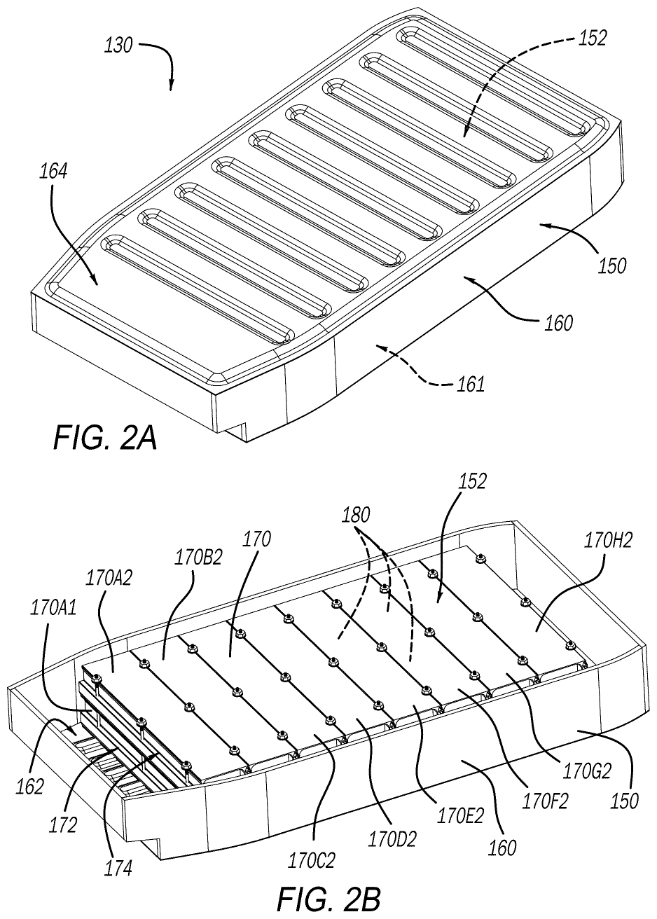

Turning now to FIGS. 2A-11, the battery pack assembly 130 constructed in accordance to various examples of the present disclosure will be described. The battery pack assembly 130 generally includes a battery housing assembly 150 that houses a battery module assembly 152. The battery housing assembly 150 generally includes a side housing 160, a bottom housing 161 and a top cover 164. As will become appreciated from the following discussion, the battery pack assembly 130 can be adapted for immersive cooling applications. In immersive cooling, a cooling liquid surrounds all of the cells to provide a cooling effect. It will be appreciated however that the principles discussed can be also adapted for use with other cooling applications such as, but not limited to, cold plate and air cooling applications.

The battery module assembly 152 comprises a plurality of battery modules, collectively identified at reference 170 and individually identified at reference numerals 170A1-170H1 and 170A2-170H2. In the example provided there are two layers 172 and 174 of battery modules 170. The first layer 172 is denoted by reference numerals 170A1-170H1. The second layer 174 is denoted by reference numerals 170A2-170H2. In the example shown, the first layer 172 is the lower layer adjacent to a bottom tray 162 while the upper layer 174 is the upper layer adjacent to the top cover 164. In examples, each battery module 170 includes a plurality of cells, collectively identified at 180. By way of example, and depending upon application, each battery module 170 can include many cells such as, but not limited to, 16, 20, 24 electrically connected cells. Other amounts of cells 180 may be incorporated in the battery modules 170 within the scope of this disclosure. The battery modules 170 of the battery module assembly 152 are interlocking with adjacent battery modules 170 providing many advantages as explained herein.

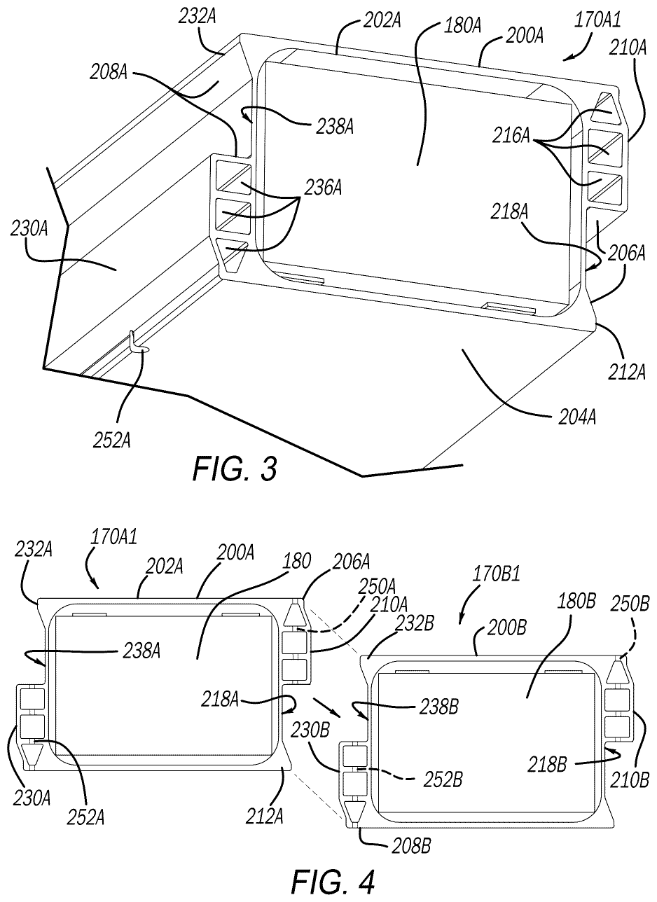

With particular reference now to FIGS. 3 and 4, additional features of the battery modules 170A1 and 170B1 will be described with the understanding that the remaining battery modules 170C-170H can be constructed similarly. The battery module 170A1 generally includes a battery module enclosure 200A that houses a plurality of respective cells 180A. In examples, the battery module enclosure 170A1 is formed of extruded aluminum.

The battery module enclosure 200A generally includes an upper frame portion 202A, a lower frame portion 204A, a first sidewall 206A and a second sidewall 208A. The first sidewall 206A generally includes a first lateral frame extension portion 210A, and a lower wing 212A. A plurality of passages 216A are formed through the first lateral frame extension portion 210A. A first groove 218A is defined between the first lateral frame extension portion 210A and the lower wing 212A. The second sidewall 208A generally includes a second lateral frame extension portion 230A, and an upper wing 232A. A plurality of passages 236A are formed through the second lateral frame extension portion 230A. A second groove 238A is defined between the second lateral frame extension portion 230A and the upper wing 232A.

The battery module 170B1 generally includes a battery module enclosure 200B that houses a plurality of respective cells 180B. In examples, the battery module enclosure 170B1 is formed of extruded aluminum.

The battery module enclosure 200B generally includes an upper frame portion 202B, a lower frame portion 204B, a first sidewall 206B and a second sidewall 208B. The first sidewall 206B generally includes a first lateral frame extension portion 210B, and a lower wing 212B. A plurality of passages 216B are formed through the first lateral frame extension portion 210B. A first groove 218B is defined between the first lateral frame extension portion 210B and the lower wing 212B. The second sidewall 208B generally includes a second lateral frame extension portion 230B, and an upper wing 232B. A plurality of passages 236B are formed through the second lateral frame extension portion 230B. A second groove 238B is defined between the second lateral frame extension portion 230B and the upper wing 232b.

As identified above, the enclosures of the respective modules 170A1-170H1 of the battery module assembly 152 interlock to form a rigid assembly. Similarly, the respective modules 170A2-170H2 interlock to form a rigid assembly. As explained herein, the respective layers 172 and 174 also interlock to form a rigid assembly. With particular reference to FIG. 4, the interlocking relationship between the enclosures 200A and 200B of the respective modules 170A and 170B will be described. While not specifically discussed, it will be appreciated that all of the remaining adjacent modules will interlock similarly.

The first sidewall 206A of the first module 170A1 interlocks with the second sidewall 208B of the second module 170B1. Explained further, the first lateral frame extension portion 210A locates into the groove 238B defined on the second enclosure 200B. Similarly, the lateral frame extension portion 230B locates into the groove 218A defined on the first enclosure 200A. First apertures 250A formed through the first sidewall 206A align with second apertures 252B formed through the second sidewall 208B of adjacent modules for receiving bolts as will be described herein.

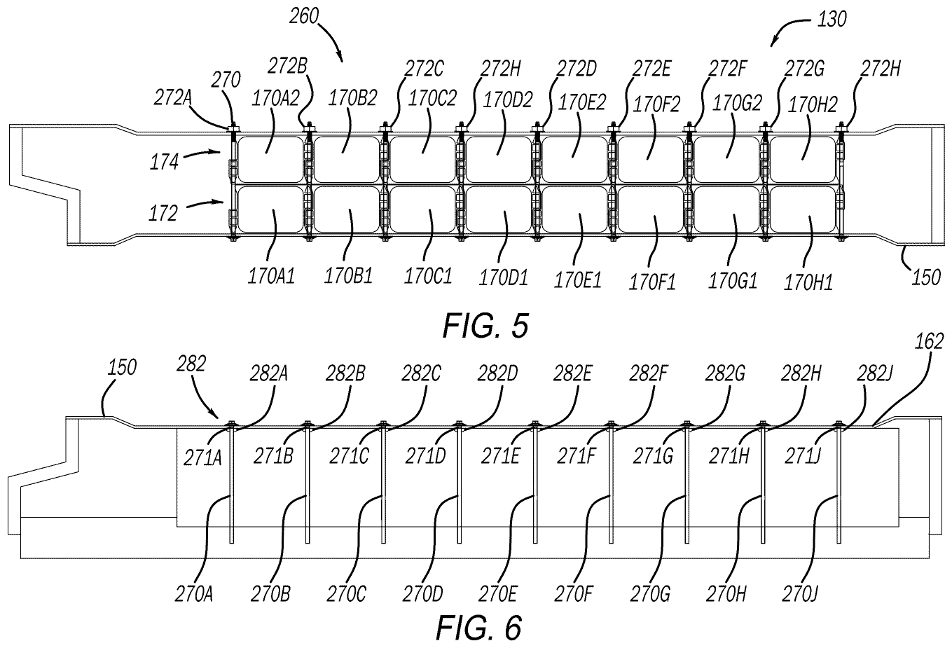

Turning now to FIG. 5, an interconnected module assembly 260 is shown having the two layers 172 and 174 of battery modules 170A1-170H1 and 170A2-170H2. In the illustration shown, bolts, collectively identified at 270 and individually identified at 270A-270H and nuts collectively identified at 282 and individually identified at 282A-282H interconnect adjacent modules as well as modules of the lower and upper rows 172 and 174 to form a rigid assembly. In particular, the enclosures 200 of all modules 170 cooperate to provide structural rigidity to the battery pack assembly 130 sufficient to protect its contents against impact, vibration and shock. This function is novel for module enclosures as such functionality was previously accomplished by dedicated cross-beams. With the battery pack assembly 130, no dedicated supplemental cross-beams are needed as the cooperating enclosures 200 provide the structural integrity.

With particular reference now to FIG. 6-11, an exemplary method of assembling the battery pack assembly 130 will be described. In general, load-bearing structures of the battery pack assembly 130 must allow for easy assembly of the battery pack, without the need for complicated fastening processes or an excessive number of parts. The battery pack assembly 130 must also allow for ease of repair if the battery pack assembly 130 must be serviced. The load-bearing structure should also not contribute excessively to the mass of the battery pack, assembly 130 or take up unnecessary volume in the battery pack assembly 130. If the mass and the volume of load-bearing structures are minimized, the chemistry of the cells 180 can be maximized to optimize battery pack energy capacity and vehicle range.

Prior art battery pack architectures use dedicated cross-beams built into the pack enclosure to provide structural integrity to the battery pack. These dedicated cross-beams serve only the purpose of structural load-bearing and nothing else. As discussed herein, the enclosures 200 of the battery modules 170 of the instant battery pack assembly 130 provide the necessary structural load-bearing properties. In this regard, and as provided in more detail below, the enclosures of adjacent modules interlock and receive fasteners (bolts, etc.) to further couple the modules 170 and establish a robust structurally sound unit. As such, no supplemental dedicated cross-beams or frame members are necessary. The interconnected modules 170 can be stacked into a single layer pack, or a dual layer pack for high energy capacity applications, such as pick-up trucks or light duty commercial vehicles. The bolted interconnected side walls 208, 210 of the modules 170 naturally form a structural beam, which provides stiffness to the battery module assembly 152 otherwise performing the function of dedicated structural cross-beams (which are now not needed).

FIG. 6 shows the battery module assembly 152 during an exemplary first assembly step showing long bolts 270A-270J being passed through respective holes 271A-271J in the bottom tray 162 and affixed thereto. In examples, the long bolts 270A-270J can be affixed with spot welds 282A-282J, or other mechanical joining process.

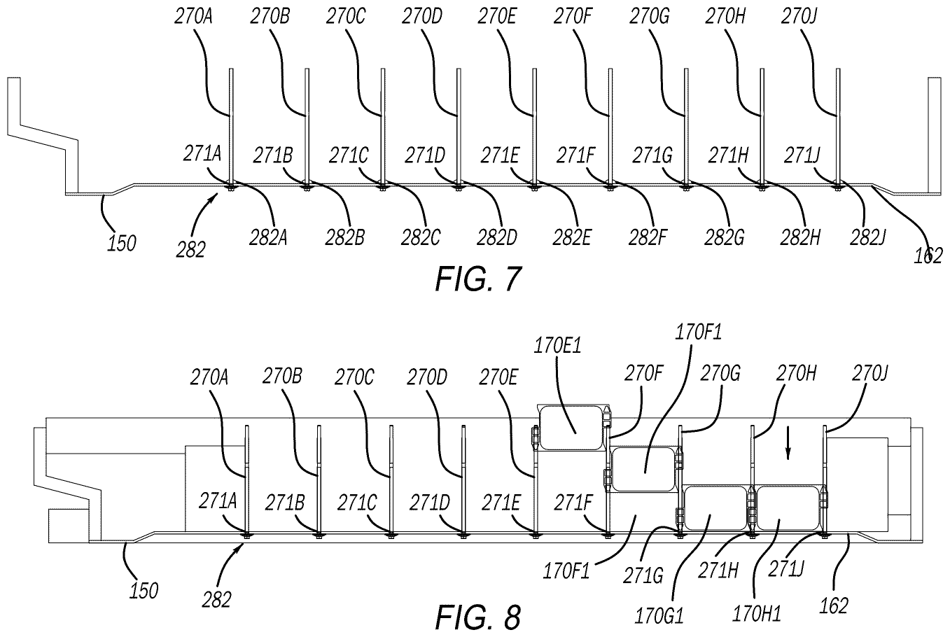

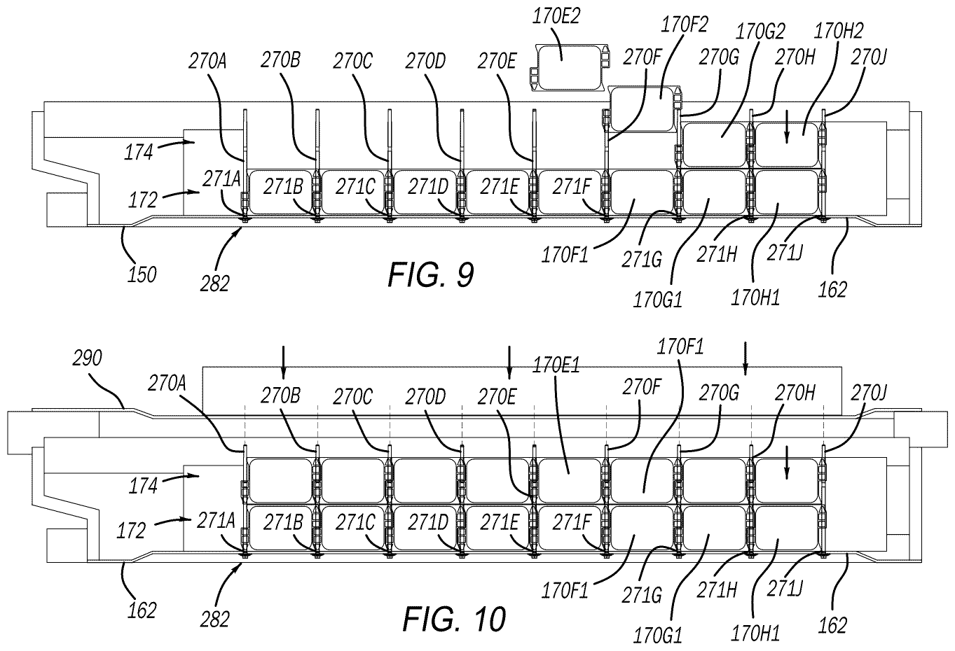

FIG. 7 is a side view of the battery module assembly 152 of FIG. 6 during an exemplary second assembly step showing the housing assembly 150 flipped over to prepare for the insertion of the modules 170. FIG. 8 is a side view of the battery module assembly 152 of FIG. 7 during an exemplary third assembly step showing a first layer 172 of modules (only modules 170E1-170H1 shown) being inserted into the housing assembly 150 using the long bolts 270A-270J as guiding pins. In particular, the long bolts 270A-270J locate through the respective apertures 250 and 252 of adjacent interlocking sidewalls 206 and 208 of the modules 170.

FIG. 9 is a side view of the battery module assembly 152 of FIG. 8 during an exemplary fourth assembly step, subsequent to completion of the first layer 172 and showing a second layer 174 of modules (only modules 170E2 170H2 shown) being inserted into the housing assembly 150 using the long bolts 270A-270J as guiding pins as described above.

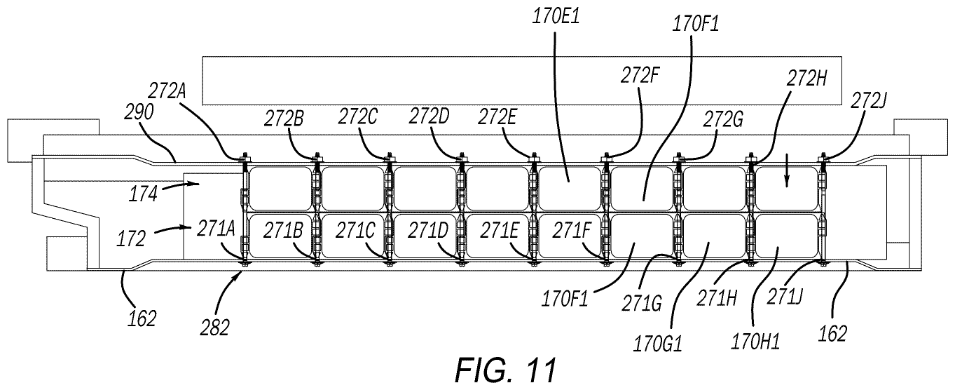

FIG. 10 is a side view of the battery module assembly 152 of FIG. 9 during an exemplary fifth assembly step showing all of the modules of the first and second layers 172 and 174 shown inserted and a battery pack top cover 290 installed over the corresponding bolts 270A-270J. FIG. 11 is a side view of the battery module assembly 152 of FIG. 10 during an exemplary sixth assembly step showing a liquid tight rubber gasket applied over each of the long bolts 270A 270J. A corresponding nut 272A-272J is threadably engaged over each of the long bolts 270A-270J and torqued to a proper specification.

The battery module assembly 152 and the battery pack assembly 130 as a whole eliminates the dedicated cross-beams completely by using the module enclosures 200 themselves to accomplish the function of prior art cross-beams. In advantages, the bolted assembly is fully repairable. With no adhesives, the process to disassemble the pack is simply the reverse of the assembly process described above and shown at FIG. 6-11. Disassembly can be done with simple tools once the battery pack has been dropped out of the vehicle. In examples the complete module assembly would be replaced. In other examples, individual modules may be serviced.

As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A battery pack assembly comprising:
a housing assembly; and
a battery module assembly disposed in the housing assembly, the battery module assembly comprising:
a first battery module that houses a first plurality of battery cells therein, the first battery module having a first enclosure including a first sidewall and a second sidewall; and
a second battery module that houses a second plurality of battery cells therein, the second battery module having a second enclosure including a first sidewall and a second sidewall;
wherein the first sidewall of the first battery module interlocks with the second sidewall of the second battery module in an assembled position.

2. The battery pack assembly of claim 1, wherein the first sidewall of the first enclosure further comprises a first lateral frame extension portion and a first wing that collectively define a first groove therebetween.

3. The battery pack assembly of claim 2, wherein the second sidewall of the second enclosure further comprises a second lateral frame extension portion and a second wing that collectively define a second groove therebetween.

4. The battery pack assembly of claim 3, wherein the first lateral frame extension portion of the first enclosure locates into the second groove of the second enclosure in an interlocking relationship in the assembled position.

5. The battery pack assembly of claim 1, further comprising a first bolt that extends through a first aperture extending through the first sidewall of the first enclosure and a second aperture extending through the second sidewall of the second enclosure.

6. The battery pack assembly of claim 5, further comprising a first nut that threadably secures to the first bolt.

7. The battery pack assembly of claim 6, further comprising a top cover positioned between the nut and the first battery module.

8. The battery pack assembly of claim 5, further comprising:
a third battery module that houses a third plurality of battery cells therein, the third battery module having a third enclosure including a first sidewall and a second sidewall;
wherein the second sidewall of the first battery module interlocks with the first sidewall of the third battery module in an assembled position.

9. The battery pack assembly of claim 8, wherein the first, second and third battery modules comprises a first layer of interconnected adjacent battery modules, the battery pack assembly further including:
a fourth battery module that houses a fourth plurality of battery cells therein, the fourth battery module having a fourth enclosure including a first sidewall and a second sidewall;
a fifth battery module that houses a fifth plurality of battery cells therein, the fifth battery module having a fifth enclosure including a first sidewall and a second sidewall;
wherein the first sidewall of the fourth battery module interlocks with the second sidewall of the fifth battery module and comprises a second layer of interconnected adjacent battery modules in an assembled position.

10. The battery pack assembly of claim 9, wherein the first bolt further extends through extends through a first aperture extending through the first sidewall of the fourth enclosure and the second aperture extending through the second sidewall of the fifth enclosure.

11. The battery pack assembly of claim 1, wherein the first and second enclosures are formed of extruded aluminum.

12. A method of assembling a battery pack assembly, the method comprising:
providing a first battery module that houses a first plurality of battery cells therein, the first battery module having a first enclosure including a first sidewall and a second sidewall;
providing a second battery module that houses a second plurality of battery cells therein, the second battery module having a second enclosure including a first sidewall and a second sidewall;
locating a long bolt through a hole defined in a bottom tray;
advancing the first battery module onto the bottom tray including passing the long bolt through a first aperture defined in the first enclosure;
advancing the second battery module onto the bottom tray including passing the long bolt through a second aperture defined in the second enclosure; and
interlocking the first sidewall of the first battery module with the second sidewall of the second battery module in an assembled position.

13. The method of claim 12, wherein the first sidewall of the first enclosure further comprises a first lateral frame extension portion and a first wing that collectively define a first groove therebetween.

14. The method of claim 13, wherein the second sidewall of the second enclosure further comprises a second lateral frame extension portion and a second wing that collectively define a second groove therebetween.

15. The method of claim 14, wherein the interlocking further comprises:
locating the first lateral frame extension portion of the first enclosure into the second groove of the second enclosure in an interlocking relationship in the assembled position.

16. The method of claim 12, further comprising welding the long bolt to the tray.

17. The method of claim 12, further comprising:
locating a top cover onto the bolt; and
threadably advancing a nut onto the long bolt.
